(19) United States
(12) Patent Application Publication
(10) Pub. No.: US 2009/0226296 A1
(43) Pub. Date: Sep. 10, 2009

(54) EFFICIENCY ENHANCEMENT AND PROTECTION METHOD FOR OCEAN, RIVER AND CHANNEL KINETIC HYDRO TURBINES

(76) Inventors: Eric L. Bibeau, Winnipeg (CA); David L.F. Gaden, Winnipeg (CA)

Correspondence Address: ADE & COMPANY INC., 2157 Henderson Highway, WINNIPEG, MB, R2G1P9, CA

(21) Appl. No.: 12/209,682

(22) Filed: Sep. 12, 2008

Related U.S. Application Data
(60) Provisional application No. 60/971,749, filed on Sep. 12, 2007.

(51) Int. Cl. F03B 11/00; F03B 3/00

(52) U.S. Cl. 415/1; 415/208.1

(57) ABSTRACT

Kinetic energy contained in oceans, rivers and channels can be converted to power using kinetic hydro turbines. These turbines can be tethered to the ocean floor, riverbed and channel bottom and their vertical position within the water column controlled. A method is disclosed that permits to increase the power extracted by the turbine by modifying the boundary layer using a shaped object located upstream of the turbine to increase the flow velocity through the turbine. The object also provides protection during climatic events like spring ice breakup, logs and storms that could damage the turbine. Additionally the shaped object can allow the turbine to be tethered to it. The shaped object can be made symmetric to allow operating in tidal conditions where the flow direction changes periodically. On site manufacturing can also alleviate overall costs.

The present application claims benefit under 35 USC Section 119(e) of U.S. Provisional Patent Application Ser. No. 60/971,749, filed on Sep. 12, 2007. The present application is based on and claims priority from this application, the disclosure of which is expressly incorporated herein by reference.

### FIELD OF THE INVENTION

The present invention relates to an improved energy generation method using kinetic water currents to increase the efficiency of kinetic hydro turbines.

### BACKGROUND OF THE INVENTION

The following patents are considered to be related to the general field of the present invention: Canadian Patents and/or Applications: 2,556,702; 2,460,479; and 2,868,717 and U.S. Pat. Nos.: 3,986,787; 4,095,918; 4,025,220; 4,163,904; 4,219,303; 4,613,279; 6,139,255; 6,406,251; 6,168,373; 6,531,788; 6,652,221; 7,105,942; and 7,291,936.

Kinetic hydro turbines extract energy from the flow by installing a horizontal or vertical turbine in a fixed position. These turbines can suffer from low power densities as a result of the riverbed, ocean floor or channel boundary layer as the flow velocity is significantly reduced in that region and the power output is proportional to the velocity cubed. In addition, these turbines risk damage from debris and from large flow velocity as a result of their exposure to the flow and elements. In addition, ocean, river and channel kinetic hydro turbines require a method to secure them against the flow. One of the methods to anchor these turbines is to use a tethered system with a cable and an anchor as taught by CIPO2556702, U.S. Pat. No. 6,168,373 and U.S. Pat. No. 6,531,788. The cable can be directly attached to the turbine or to a pontoon floating on the top of the channel securing the turbine in place, as taught by U.S. Pat. No. 3,986,787, U.S. Pat. No. 4,095,918, U.S. Pat. No. 7,105,942 and U.S. Pat. No. 7,291,936.

Anchoring blocks have been used to secure kinetic hydro turbines, however these blocks have only been used with the purpose of providing a means of anchoring the turbine. To increase the turbine efficiency, prior art teaches that inlet nozzles and outlet diffusers are fluid dynamic components that increase the power density for kinetic turbines, as taught by CIPO2556702, CIPO2460479, U.S. Pat. No. 3,986,787, U.S. Pat. No. 4,095,918 and U.S. Pat. No. 4,025,220. Prior art also teaches about ducted turbines in channels used to increase the power density. These methods are different from the method disclosed herein because they enclose the rotor, and are part of the kinetic turbine assembly. In the current disclosure the upstream object is installed independently of the kinetic hydro turbine. To protect the kinetic turbine against damage, prior art teaches that debris can be guarded against using screens, as taught by CIPO2460479 and U.S. Pat. No. 4,613,279. These methods differ from the method disclosed herein because screens or filters are not used. Prior art also teaches that the turbine can be designed to be moveable, allowing it to be lifted out of the flow when necessary, as taught by U.S. Pat. No. 6,652,221.

### SUMMARY OF THE INVENTION

According to one aspect of the invention there is provided a method of increasing power density of a kinetic hydro turbine in a flow of fluid which flows along a boundary surface which contains the flow of fluid and which forms a boundary layer in the flow of fluid, the method comprising:

disturbing the boundary layer of the flow of fluid by locating an object in the flow of fluid upstream from the turbine and shaping the object so as to move fluid in the flow away from the boundary surface upstream from the turbine.

The disclosed method consists of an object placed on the ocean floor, riverbed or channel bottom upstream of the kinetic hydro turbine. The size and geometry of the object is optimized to disturb the boundary layer to increase the power density seen at the turbine. The object is also selected for its ability to form a large wake region to allow protecting the turbine when needed. Symmetrical shapes offer the added advantage to perform similarly in tidal applications where the flow changes direction periodically.

Computational fluid dynamic analyses performed by the authors show that boundary layer disturbing shapes that produce the largest upward flow velocities exhibit the greatest power increase at the turbine. The results show that shapes designed to produce jet-like wake flows, such as that from nozzle, tend to exhibit the smallest power increases. Thus the size and geometry of the object is selected to produce a wake region sufficiently large to allow protecting the kinetic turbine during climatic events that could damage or destroy the turbine. The turbine can be positioned within this protective region whenever flow conditions are deemed unsafe, such as with debris-laden spring run-off, or when the velocities are above the design limits of the turbine. Furthermore, computational fluid dynamic analyses demonstrate that the geometries that increase energy-densities also produce large wake zones. That is, increases in the flow velocity above the shaped object also increase the wake region for protection. The modifying boundary layer object can be designed as an anchoring base for the ocean, river and channel kinetic hydro turbine.

More particularly, the disclosed invention consists of placing a boundary layer disturbing object at the bottom of an ocean floor, riverbed and channel bottom to modify the boundary layer. The shape of the boundary layer disturbing object is optimized to provide a velocity increase above and downstream of the shaped object to increase the power density of the kinetic hydro turbine and to provide a wake region behind the shaped object to reduce the flow velocity and thereby avoid damage to the turbine when environmental elements like heavy logs, storms and spring ice breakup risk damaging or destroying the hydro kinetic turbine.

Preferably the turbine is located in a region of the flow affected by the boundary layer prior to placement of the object in the flow.

The method according to the present invention may further include disturbing the boundary layer of the flow by locating the object adjacent the boundary surface forming the boundary layer.

When the flow of fluid is a river, the boundary surface preferably comprises a bed of the river.

When the flow of fluid is an ocean current, the boundary surface preferably comprises a bed of the ocean.

When the flow of fluid flows through a channel, the boundary surface preferably comprises channel walls defining the channel.

The method may include arranging said object in the flow of fluid to produce a wake zone comprising a turbulent recirculation region downstream from the object and locating the turbine outside of the wake zone, but preferably adjacent to the wake zone.

The turbine may be located farther from the boundary surface than the wake zone in a region of maximum flow in a direction of the flow extending generally parallel to the boundary surface.

The method may include shaping said object to have a cross-sectional area perpendicular to the direction of the flow which is plural times greater than a cross-sectional area in the direction of the flow so as to maximize a cross-stream area of said object.

A distance of the turbine from the boundary surface may be arranged to be near a maximum outward dimension of said object relative to the boundary surface.

The turbine may also be located farther from the boundary surface than an outermost end of said object which is farthest from the boundary surface.

The method may further comprise: arranging said object in the flow of fluid to produce a wake zone comprising a turbulent recirculation region downstream from the object; and protecting the turbine by locating the turbine in the wake zone of said object. In this instance, the turbine may be located fully in the wake zone.

The distance of the turbine from the boundary surface may be arranged to be near a maximum outward dimension of said object relative to the boundary surface.

The turbine may also be located nearer to the boundary surface than an outermost end of said object which is farthest from the boundary surface.

Preferably the method also includes substantially wholly anchoring the turbine to said object.

The object is preferably located in the flow to be fully separate and independent of the turbine.

The object can be shaped to maximize outward flow velocity of the disturbed boundary layer away from the boundary surface.

Further the trailing edge of said object may be shaped to maximize a wake zone produced by said object.

Preferably the object is shaped to maximize an effect of the object on the boundary layer in the flow of fluid to redirect the boundary layer outward from the boundary surface.

When a leading side of the object is arranged to span generally from an inner edge adjacent an inner end of the object adjacent the boundary surface to an outer edge adjacent an outer end of the object farthest from the boundary surface, preferably the outer edge is spaced in a direction of the flow towards a trailing edge of the object in relation to the inner edge.

A leading side of the object may comprise a ramp surface extending generally outward from the boundary surface in a direction of the flow towards a trailing side of the object. The ramp surface may be generally concave in profile or generally inclined in profile.

The object is preferably symmetrical about a plane oriented transversely to a direction of the flow of fluid.

Locating the object in the flow of fluid may be accomplished by: locating a shaped membrane at a desired located of the object in the flow of fluid; injecting a fluid material into the shaped membrane; and arranging the fluid material to solidify in the form of the shaped membrane to form said object.

When there is provided a plurality of kinetic hydro turbines, the method may include locating a plurality of objects in the flow of fluid and locating each of the plurality of kinetic hydro turbines in a region of disturbed boundary layer by a respective one of the plurality of shaped objects, or locating the plurality of kinetic hydro turbines in a common region of disturbed boundary layer by said object.

The method may further comprise arranging said shaped object in the flow of fluid to produce a turbulent wake region downstream from the object; operating the turbine in a location outside of said turbulent wake region; and displacing the turbine from the location outside of said turbulent wake region to a location within the turbulent wake region responsive to determination of a debris condition.

According to a further aspect of the present invention there is provided a method of protecting a kinetic hydro turbine in a flow of fluid, the method comprising:

locating an object in the flow of fluid upstream from the turbine so as to produce a wake zone; and

locating the turbine in the wake zone.

### BRIEF DESCRIPTION OF THE DRAWINGS

FIG. 1 shows numerical results showing the high velocity region and wake region in relation to the shaped object

FIG. 2a shows a typical arrangement of a preferred embodiment of the invention to increase the power density through the turbine by disturbing the flow boundary layer with a shaped object and provide a wake region for protection

FIG. 2b shows an alternative positioning of the turbine using a pontoon arrangement

FIG. 3a and FIG. 3b show alternate placement of shaped objects

FIG. 4 shows shaped objects with geometries labelled A to F

FIG. 5 shows calculated flow streamlines around shaped objects A to F

FIG. 6a shows power profiles for shaped objects A to F with kinetic hydro turbine six metres from shaped objects

FIG. 6b shows power profiles for shaped anchors A to F with kinetic hydro turbine sixteen metres from shaped objects

FIG. 6c shows power profiles for shaped anchors A to F with kinetic hydro turbine thirty-six metres from shaped objects

FIG. 7 peak power for shaped anchors A to F with kinetic turbine six metres from shaped objects at the water surface

In the drawings like characters of reference indicate corresponding parts in the different figures.

### DETAILED DESCRIPTION

Referring to the accompanying figures there is illustrated a boundary layer disturbing object generally indicated by reference numeral 10. The device 10 is particularly suited for use in a fluid flow, for example a river, an ocean current or other flow bounded in a channel-like structure, to disturb a boundary layer in the flow caused by the flow flowing along a boundary surface 12, thus increasing the power density of a turbine 14 situated in the flow.

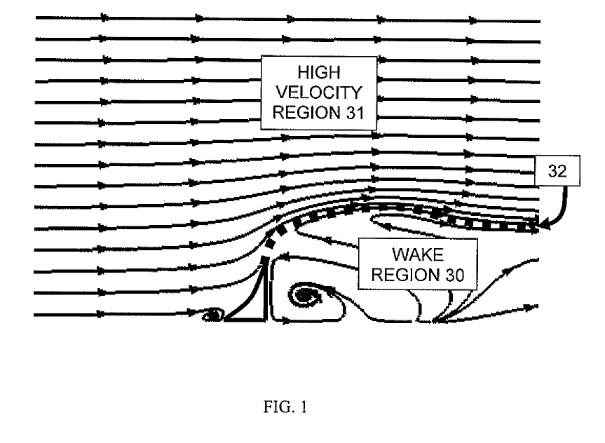

FIG. 1 shows flow streamlines 16 and velocity contours 17 from numerical flow modelling calculations with shaped object 10 and boundary surface 12. Boundary line 32 separates the flow into high velocity region 31 located above shaped object 10 and wake region 30 located behind shaped object 10.

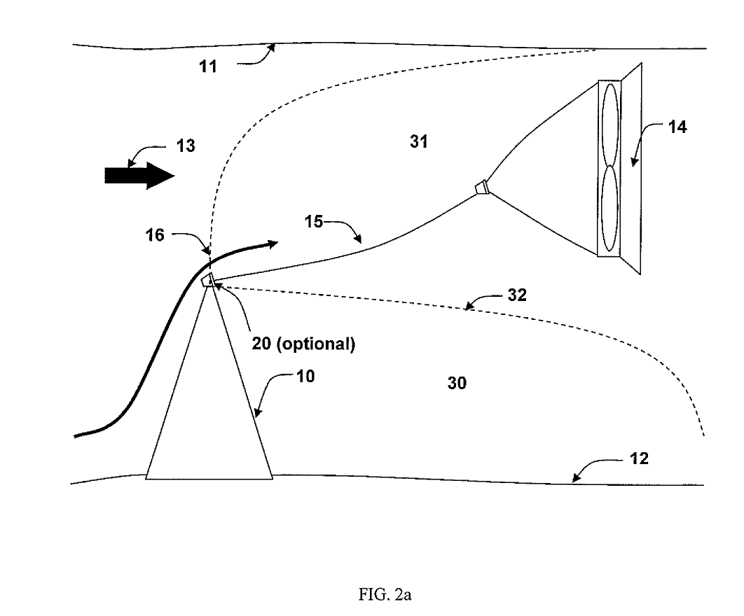

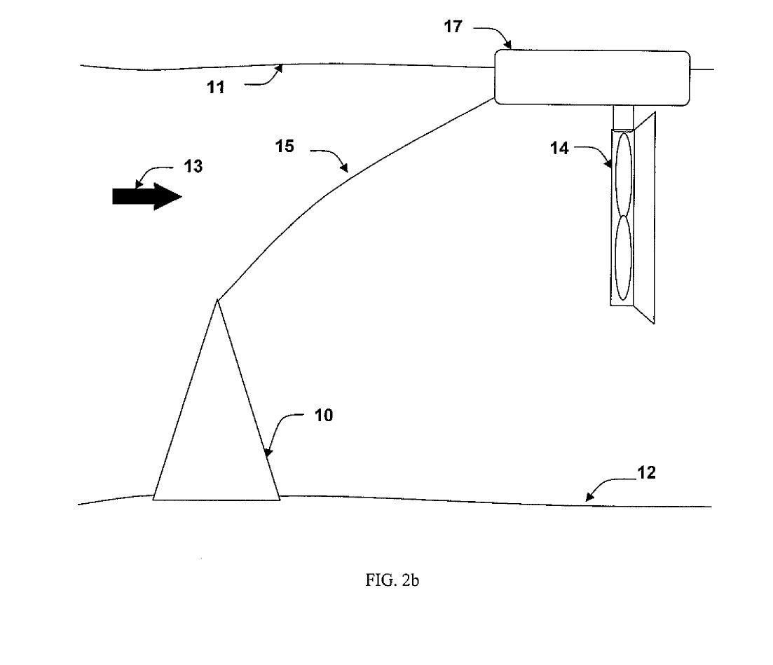

FIG. 2a shows a preferred embodiment that increases the power density of kinetic hydro turbine 10 and offers protection to said turbine from the elements when required. In FIG. 1 and FIG. 2a there is a section of an ocean, river or channel where water flows along boundary surface 12. In this instance the boundary surface forms a floor above which the fluid flows. Kinetic hydro turbine 14 is situated in flow 13 at a location spaced upwardly from boundary surface 12 and below water surface 11 to capture kinetic energy from said flow. Shaped object 10 is a boundary layer disturbing object particularly suited for use in a fluid flow, for example, a river, an ocean current or other flow bounded in a channel-like structure, to disturb the boundary layer in the flow caused by the fluid flowing along boundary surface 12, thus increasing the power density of tethered kinetic hydro turbine 14. Shaped object 10 produces high flow velocity region 31 located above said shape anchor and wake region 30 located downstream and behind shaped object 10. The size and velocity distribution of high flow velocity region 31 and of wake region 30 can be obtained from numerical modelling as shown previously in FIG. 1 or from experimental tests using dynamic similarity.

The geometry of shaped object 10 is optimized so as to increase the power density of kinetic hydro turbine 10 by creating favourable flow streamlines 16 while considering the size of wake region 30 and the advantage offered by a symmetrical shape object for tidal applications. Kinetic hydro turbine 14 is tethered to shaped object 10 using cable 15 and can move within the vertical column to a location corresponding to the maximum power in high flow velocity region 31 and also move in wake region 30 to protect itself from damage form environmental elements. Kinetic hydro turbine 14 is either a horizontal turbine, a vertical turbine and can consist of a plurality of turbines optionally connected together. Swivel joint 20 is optional and used for tidal application where flow 13 changes direction periodically.

FIG. 2b shows another preferred embodiment where kinetic hydro turbine 14 is secured using floating pontoons 17. In this arrangement kinetic hydro turbine 14 may not be able to dive and be protected by wake region 30 to avoid damage from environmental elements.

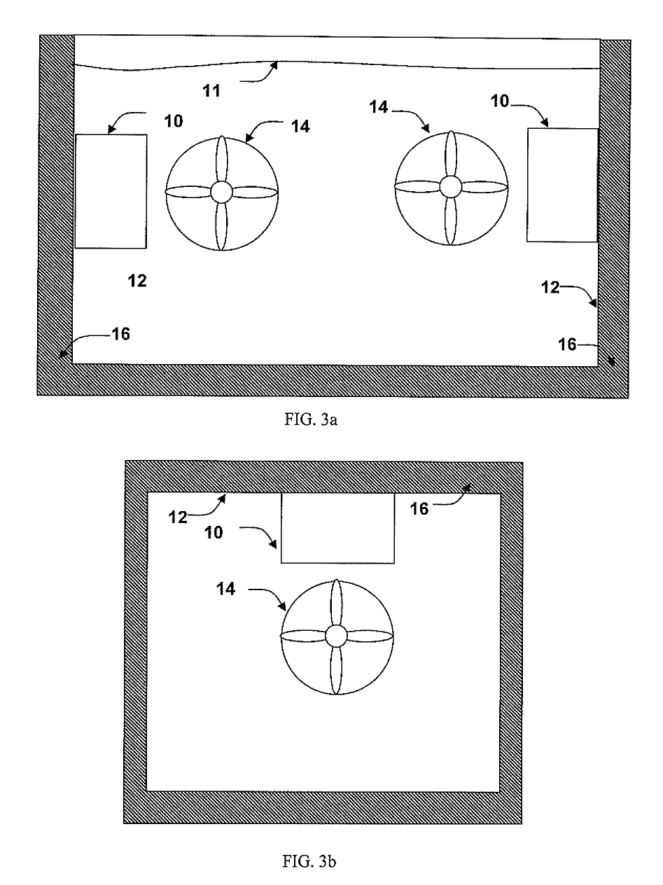

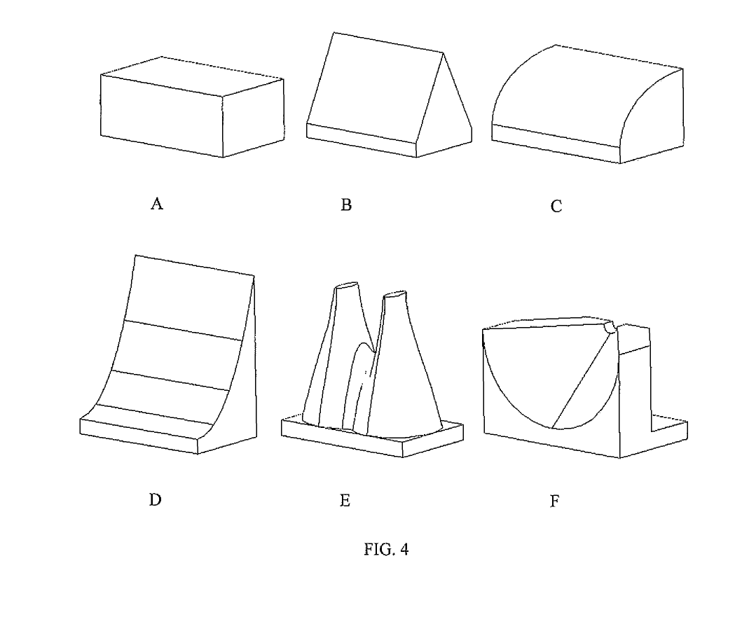

FIG. 3a and FIG. 3b illustrate a frontal view of further embodiments of fluid flows which may be bounded by channel walls either on sides, at bottom and on top of the flow. Each of the channel walls 16 defines a boundary surface 12 which contains the flow and along which the fluid flows so that a resulting boundary layer is formed along said boundary surface. In an ocean, river or channel, the boundary layer can be of the same scale as the depth of the flow. Kinetic hydro turbine 14 is aligned in the flow direction and shaped object 10 is placed to one or adjacent one of boundary surfaces 12 that is close enough or near enough to the turbine that it forms a boundary layer which affects the turbine performance. Shaped object 10 serves to redirect the boundary layer flow around and over said object. That is shaped object 10 redirects the flow outward and away from the boundary surface so that the boundary layer flow reaching the turbine is affected when the object is appropriately spaced upstream from the turbine.

Shaped object 10 also serves to form a wake region comprising a turbulent recirculation region extending downstream from the object. When it is desirable to achieve maximum power output from the turbine, the turbine is located approximately as shown in FIG. 2a, FIG. 3a and FIG. 3b so as to be outside but adjacent the wake region in a region of maximum horizontal flow or maximum flow in flow direction. In this instance the turbine is typically located near or above a height of the shaped object 10 in relation to the relevant boundary surface 14. That is the turbine is spaced outwardly from the boundary surface by a distance which is equal or generally exceeds spacing of the outer most end of the object in relation to the boundary surface.

Alternatively when it is desirable to provide some protection to the turbine from storms and debris carried by the flow of fluid, the turbine is typically located fully within wake region 30, but still spaced downstream from shaped object 10. When locating kinetic hydro turbine 14 fully in wake region 30, said turbine is typically located near or below a height of shaped object 10 dependent upon the distance of said turbine from the said shaped object in the flow direction. In this instance, kinetic hydro turbine 14 is typically located at a smaller outward distance from boundary surface 12 than an outer end of shaped object 10. The turbine may be initially operated outside of the turbulent wake region and then displaced from outside the wake region to a location within the wake region only in response to detection or determination of debris in the flow which may indicate a temporary condition where increased protection of the turbine is desired.

The shaped object 10 typically comprises a block which is cast of concrete or other suitable dense rigid material capable of being readily formed with sufficient mass or bottom protrusions to also anchor kinetic hydro turbine 14 against flow 13. Methods of fabrication for the shaped object 10 include, for example, a precast mould where said shaped object after being manufactured is lowered into the water, and by injection of fluid material on location into a pre-shaped or pre-formed membrane in which the fluid material is capable of solidifying in the water. In the later instance, the membrane is first submerged into the flowing body of water. The membrane then holds the fluid material in a shape corresponding to the desired shape of the finished object until the fluid material cures or solidifies in situ to form the finished object. The shaped object 10 is fully independent from kinetic hydro turbine 14 being connected to the shaped object by suitable tethers to anchor the turbine. Shaped object 10 which disturbs the boundary layer typically wholly anchors kinetic hydro turbine 14 against the flow.

In typical embodiments, when one or more turbines are provided, one boundary layer disturbing shaped object 10 is provided in association with each kinetic hydro turbine 14 respectively. In further arrangements however there may be provided a plurality of separate shaped objects 10 or separate blocks forming shaped object 10 which anchors a single kinetic hydro turbine 14. In yet further embodiments there may be provided a single common boundary layer disturbing shape object 10 which anchors and disturbs the boundary layer in relation to a plurality of turbines 14 associated therewith.

The particular shape and configuration of shaped object 10 may vary while still providing the proper function of disturbing the boundary layer to increase the power density of the flow at the turbine. Numerical test indicate that a ramped leading side at the front of shaped object 10 which faces into and confronts the flow is desirable. In particular the leading side of said shaped object is particularly effective when sloped or inclined upwardly away from relevant boundary surface 12 in the flow direction towards a rearward trailing side of the object. In this arrangement the leading side of the object acts to maximize the upward flow outward and away from relevant boundary surface 12 to maximize the vertical effect of outward disturbance of the flow relative to said boundary surface.

Turning now to FIG. 4 and Label A, a first embodiment of shape object 10 is illustrated in which the object comprises a rectangular block which is positioned in the flow so as to have a greater extent in lateral direction perpendicular to the flow than in the flow direction. The leading and trailing sides are oriented perpendicularly to the flow. While this embodiment has some beneficial effect, other embodiments appear to have greater positive effect.

FIG. 4 and Label B illustrates a second embodiment of shaped object 10 in which both the front leading side and rear trailing side of the object are sloped at a flat incline in profile. In particular the front leading side tapers at an incline outwardly from the boundary surface in the flow direction while meeting the rear trailing side at an outer apex such that the rear trailing side is inclined inwardly towards the boundary surface in the flow direction.

A further embodiment is shown in FIG. 4 and Label C in which shape object 10 has the geometry of a section of a cylinder so that the laterally spaced apart ends, the rear trailing side, and the bottom side against boundary surface 12 are all generally flat and rectangular, but the front leading side and the top outer side farthest from the boundary surface form a continuous curving surface which is convex in profile so that the leading surface or leading side of shape object 10 again extends outwardly from the boundary surface at an incline in the flow direction from the front bottom edge to the rear top edge of said shaped object.

FIG. 4 and Label D illustrates another alternative embodiment in which shaped object 10 forms an aggressive upwardly curving ramp in which the front leading side is concave in profile to sharply redirect the flow along a continuous curve. In this instance the lower portion of the leading side of the object nearest to the boundary surface is near parallel to the boundary surface and the flow direction before curving upwardly and outwardly to be near perpendicular to the boundary surface and the flow direction near the outer top end of the object farthest from the boundary surface. In this instance, shaped object 10 appears to maximize the upward and outward redirection of the boundary layer flow away and outward from the boundary surface to maximize the disturbance of the boundary layer of the flow away from the boundary surface and offer the most benefit to the turbine.

Turning to FIG. 4 and Label E, a further embodiment of shaped object 10 is illustrated in which said object generally comprises a pair of laterally spaced cone shaped structures projecting upwardly and tapering to a narrower dimension as the cones extend away from boundary surface 12. The cones are joined by a bridge section which connects the cones to form a continuous wall there between to a height which is partway, and typically greater than half the height thereof, in relation to the boundary surface. Shape object 10 in this instance defines a pair of end portions having the greatest height in relation to the boundary surface and a central portion spanning there between which is less in height in relation to the boundary surface so that the flow is concentrated between the end portions at the upper half of shaped object 10 above the central portion thereof. The end portions and the central portions together define the leading side of the object which again slopes upwardly and away from the boundary surface in the flow direction to maximize disturbance of the boundary layer flow away from boundary surface 12.

Turning to FIG. 4 and Label F, a further embodiment of shaped object 10 is illustrated in which the leading side of the object defines a partial cone shaped funnel which is generally concave in cross section. The leading side thus defines sides which are sloped from opposing lateral ends of the object towards a center of the object in the flow direction from the leading side to the trailing side. The funnel structured leading side also defines a bottom portion which slopes upwardly and away from the boundary surface from the leading side to the trailing side. The side portions and the bottom portion are all continuous with one another to form a generally U-shaped leading side which tapers upwardly and inwardly towards a center of the block at the rear trailing side thereof in the flow direction. This shape functions to concentrate the flow towards a center of the object 10 similarly to the embodiment of FIG. 4 and Label E. The majority of the surface of said shaped object again slopes away from the boundary surface in the flow direction to maximize the outward redirection of the boundary layer flow from boundary surface 12.

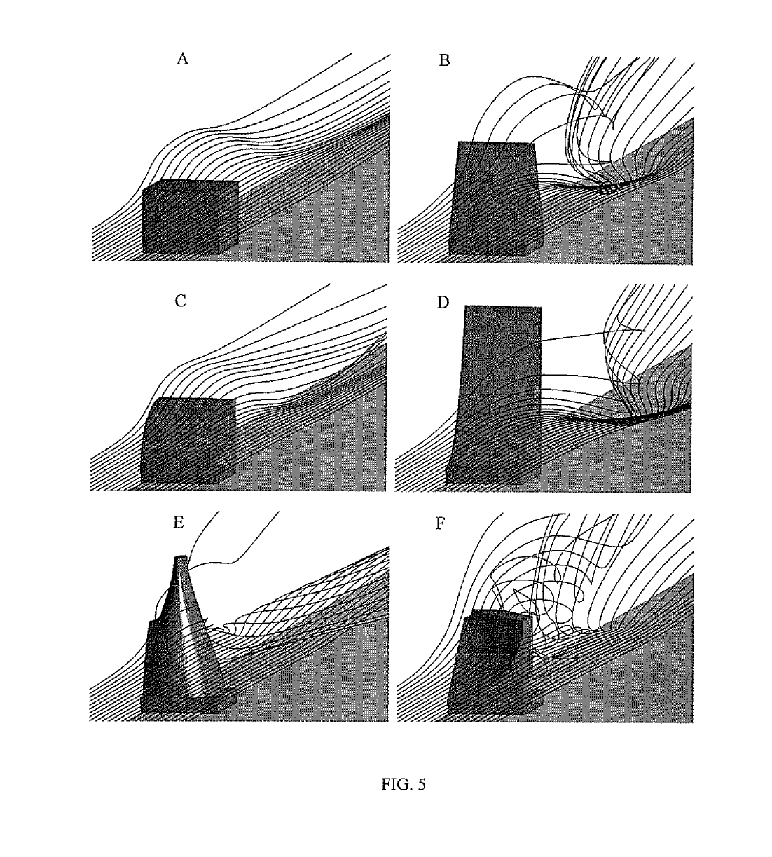

FIG. 5 shows flow streamlines 16 numerically calculated for the shaped objects Labelled A through F. In all these instances, the volume and the base footprint area of each of the shaped objects were kept constant during the numerical calculations.

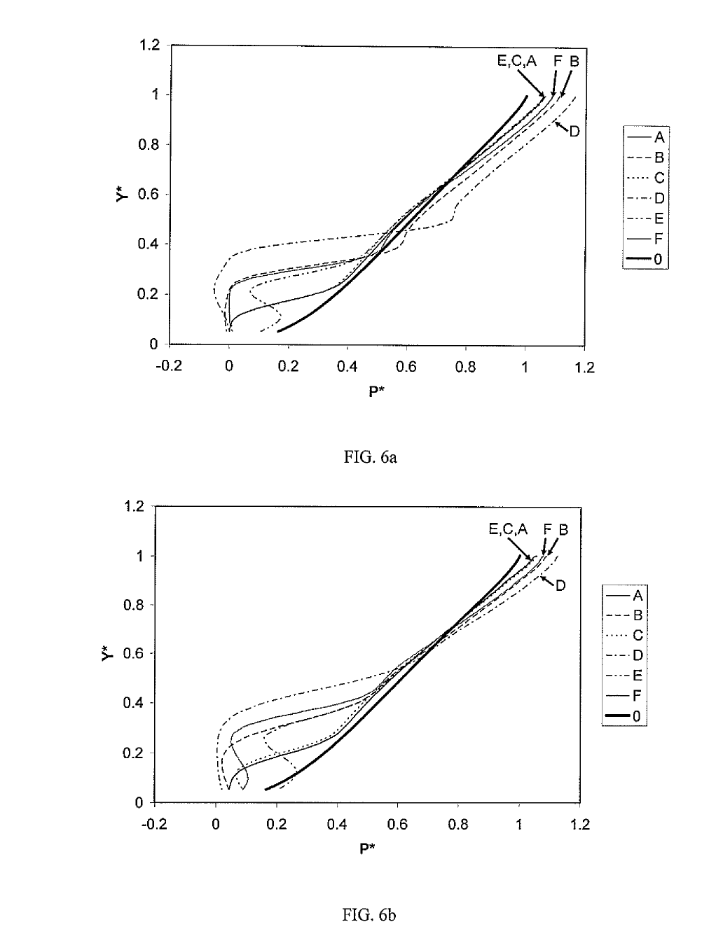

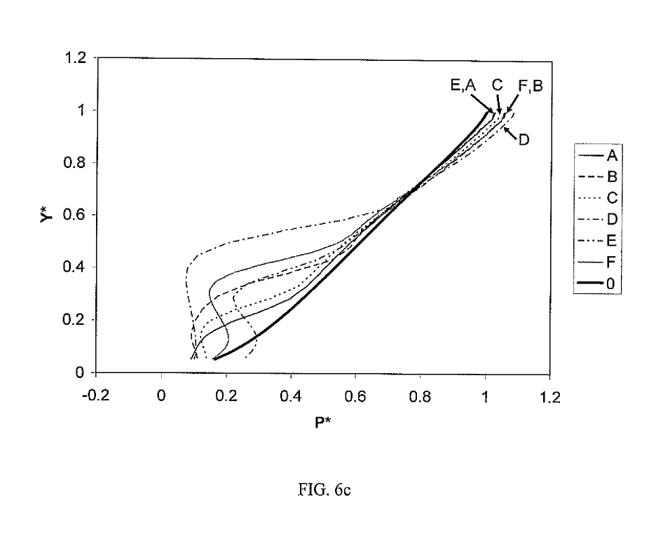

The performance obtained from numerical calculations of the various embodiments in FIG. 5 for Labels A through F are shown in FIG. 6a, FIG. 6b and FIG. 6c for shaped objects located six meters, sixteen meters, and thirty-six metres, respectively, upstream of kinetic hydro turbine 14. In these figures, Y*, is the non-dimensional height of the water column varying from 0 to 1 and, P*, is the non-dimensional power passing through a disk situated at the top of the channel when no boundary layer shaped object 10 is present. The numerical results shows that shaped object 10 Label D which maximizes the outward redirection of the boundary layer flow from boundary surface 10 achieves the greatest power increase.

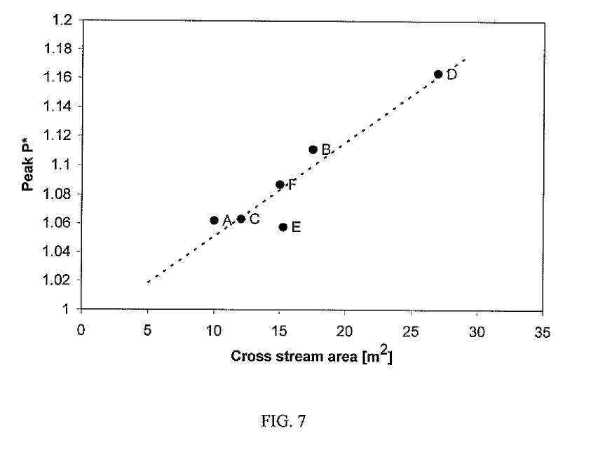

FIG. 7 compares shape objects Labels A through F. This figure shows peak power, P*, obtained as function of the frontal cross-sectional area perpendicular to the flow of the shape objects. For the numerical calculations the volume and footprint are kept constant. FIG. 6 shows that a 6% to 17% increase in power is possible using shape objects 10 Label A through F with Label D being most effective.

Since various modifications can be made to the invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of increasing power density of a kinetic hydro turbine in a flow of fluid which flows along a boundary surface which contains the flow of fluid and which forms a boundary layer in the flow of fluid, the method comprising:
disturbing the boundary layer of the flow of fluid by locating an object in the flow of fluid upstream from the turbine and shaping the object so as to move fluid in the flow away from the boundary surface upstream from the turbine.

2. The method according to claim 1 wherein the flow of fluid is a river and the boundary surface is a bed of the river, or the flow of fluid is an ocean current and the boundary surface is a bed of the ocean, or the flow of fluid is a channel and the boundary surface comprises channel walls.

3. The method according to claim 1 including arranging said shaped object in the flow of fluid to produce a turbulent wake region downstream from the object and locating the turbine outside said turbulent wake region.

4. The method according to claim 3 including locating the turbine farther from the boundary surface than the wake region in a region of maximum flow in a direction of the flow extending generally parallel to the boundary surface.

5. The method according to claim 1 including forming the geometry of said shaped object to maximize the flow velocity in a direction of the flow extending generally parallel to the boundary surface in the fluid flow downstream from said object.

6. The method according to claim 1 including:
arranging said shaped object in the flow of fluid to produce a turbulent wake region downstream from the shaped object; and
protecting the turbine by locating the turbine in the wake region of said shaped object.

7. The method according to claim 6 including locating the turbine fully in the wake region.

8. The method according to claim 1 including anchoring the turbine to said shaped object.

9. The method according to claim 8 including substantially wholly anchoring the turbine to said shaped object.

10. The method according to claim 1 including locating said shaped object in the flow of fluid separately and independently of the turbine.

11. The method according to claim 1 including forming the geometry of said shaped object to maximize outward flow velocity of the disturbed boundary layer away from the boundary surface.

12. The method according to claim 1 including forming the geometry of said shaped object to maximize a distance from the boundary surface of the disturbance of the boundary layer in the flow of fluid.

13. The method according to claim 1 including forming the geometry of said shaped object to maximize the size of the turbulent wake zone.

14. The method according to claim 1 including forming a leading side of the object to comprise a ramp surface extending generally outward from the boundary surface in a direction of the flow towards a trailing side of the object.

15. The method according to claim 14 including forming the ramp surface of the object to be generally inclined in profile.

16. The method according to claim 1 including locating the object in the flow of fluid by:
locating a shaped membrane at a desired located of the object in the flow of fluid;
injecting a fluid material into the shaped membrane; and
arranging the fluid material to solidify in the form of the shaped membrane to form said object.

17. The method according to claim 1 for a plurality of kinetic hydro turbines wherein the method includes locating a plurality of objects in the flow of fluid and locating each of the plurality of kinetic hydro turbines in a region of disturbed boundary layer by a respective one of the plurality of shaped objects.

18. The method according to claim 1 for a plurality of kinetic hydro turbines wherein the method includes locating the plurality of kinetic hydro turbines in a common region of disturbed boundary layer by said object.

19. The method according to claim 1 including arranging said shaped object in the flow of fluid to produce a turbulent wake region downstream from the object; operating the turbine in a location outside of said turbulent wake region; and displacing the turbine from the location outside of said turbulent wake region to a location within the turbulent wake region responsive to determination of turbine damage risk condition.

20. The method according to claim 1 including locating the turbine in a region of the flow affected by the boundary layer prior to placement of the object in the flow.
